(19) United States
(12) Patent Application Publication
(10) Pub. No.: US 2007/0177392 A1
(43) Pub. Date: Aug. 2, 2007

(54) Lighting fixture

(76) Inventor: Vladimir Grigorik, Burlington (CA)

Correspondence Address: VLADIMIR GRIGORIK, c/o UNIT 33 -2280 MUNN'S AVENUE EAST, OAKVILLE, ON, L6H 3L1, CA

(21) Appl. No.: 11/340,435

(22) Filed: Jan. 27, 2006

(51) Int. Cl. F21V 19/00

(52) U.S. Cl. 362/382

(57) ABSTRACT

A lighting fixture comprises a base portion and at least one valance portion oriented so as to project outwardly from the base portion. The at least one valance portion is connected in heat conductive relation to the base portion, to thereby act as a heatsink. There is at least one light source mounted on one of the base portion and the at least one valance portion, such that the at least one valance portion is substantially adjacent the at least one light source, to thereby obstruct the direct viewing of the at least one light source from beyond the at least one valance portion when the lighting fixture is installed on a supporting structure.

### FIELD OF THE INVENTION

The present invention relates to lighting fixtures, and more particularly to heatsinks and valances for lighting fixtures.

### BACKGROUND OF THE INVENTION

Lighting fixtures, also known as luminaries, are defined as a complete lighting unit consisting of a light source together with the parts designed to distribute the light, to position and protect the light source, and to connect the light source to a power supply. It is very important, and in many cases necessary, to have a luminaire with the proper luminous intensity distribution for successful lighting. Luminaries can produce patterns of light that are interesting and important with respect to the appearance of the space being lit. The requirements for contrast and luminance determine the luminous intensity distribution and the placement of luminaries.

In many instances, both direct and indirect lighting are commonly needed to properly illuminate either a display area or a work area. It is common when illuminating a display area or a work area, to use a lighting fixture mounted on a horizontal surface such as a ceiling or shelf, or mounted on a vertical surface such as a wall, or even to suspend the lighting fixture from a supporting structure, such as a ceiling. In such installations, the eye level of persons in a typical viewing area must be considered, as it is undesirable to view the light source directly. Further, newly developed high brightness light emitting diodes can generate twelve to fifteen candela as a point light source under normal lighting conditions, which is intensely bright and therefore undesirable to view directly. Accordingly, it is important to generally obstruct the direct viewing of the light source by a person from typical viewing areas, in order to achieve high visual comfort for persons.

Conventionally, a simple valance is used to at least partially obstruct the direct view of the light source. A valance can extend a suitable distance downwardly or upwardly from a horizontal surface, outwardly from a vertical surface, as required. In order to properly establish the size and position of a valance with respect to a lighting fixture, a cut-off angle is determined. The cut-off angle is the angle formed by a line drawn from the direction of the direct light rays at the light source with respect to the vertical, beyond which no direct light is emitted. Typically, the cut-off angle is quite important when designing at lighting fixture and a valance. It is necessary that this cut off angle be such that the eye level of most persons is above the cut off angle, so as to have the light source obstructed from direct viewing by a person, but still properly illuminate the display area or work area.

Further, a valance significantly reduces the amount of overall glare associated with a lighting source and the illumination of an area, such as a work area or a display area. Such glare typically reduces task performance, which is undesirable for a work area.

It is common practice to construct a valance as an architectural element of a cabinet or cove structure, as appropriate. Often, valances are constructed from wood, but may be constructed from any other suitable building material. Such construction of a valance is typically time consuming, inconvenient, and adds additional cost to the overall structure.

Further, proper thermal management is critical in the design of lighting fixtures, especially those that have light emitting diodes as a light source, since temperature significantly affects light emitting diode performance and reliability. Light emitting diodes generate heat due to electrical power dissipation. If the junction temperature of the light emitting diode is higher than its rated junction temperature, the output of the light emitting diode will be reduced, the dominant wavelength or perceived colour of the light emitting diode will change, and the light emitting diode may be driven to wear out prematurely or even to catastrophic failure.

In order to dissipate the heat generated by light emitting diodes, it is common to mount the light emitting diodes on thermally conductive interface materials as a heat spreader. For example, Metal-Core-Printed-Circuit-Board (MCPCB) are commonly used as the thermal management solution for high-powered surface mounted light emitting diodes. Metal-Core-Printed-Circuit-Boards have a dielectric coated metal base with a bonded copper circuit layer. However, the desire to achieve maximum light intensity from a compact package, forces light emitting diode manufacturers to design light engines such that the light emitting diodes are mounted quite closely to each other. Accordingly, the power density becomes unacceptably high and the Metal-Core-Printed-Circuit-Boards or other type of heat spreader tends to become unacceptably hot. It has been found that it is necessary to use an additional heatsink of some sort in order to properly dissipate the unwanted heat.

Another reason that heat dissipation is necessary, or at least desirable, is that the temperature of the lighting fixture must be kept at an acceptable level in case a person comes in contact with the lighting fixture.

Unfortunately, it is generally inconvenient, costly, complicated and difficult to mount a heatsink on a linear light emitting diode light engine. The proper size of the heatsink must first be calculated. The acceptable shape of the heatsink must then be determined. Next, a source of the appropriate heatsink must be found. Finally, the heatsink must be mounted on the linear light emitting diode light engine.

It can therefore be readily seen that, in the prior art, in order to provide a linear light emitting diode light engine with a heatsink and also install it with a valance is generally inconvenient, costly, complicated and difficult, and time consuming. Further complicating matters, it is usually necessary that the entire lighting arrangement be aesthetically attractive, which is difficult to accomplish using a conventional heatsink, especially in combination with a valance.

United States Patent Application Publication No. 2005/0201098, published Sep. 15, 2005, discloses an Interior Lamp for use in a vehicle. This interior lamp comprises a heatsink having a top portion with the side portions angled outwardly and downwardly from the top portion. The cooling fins of the heatsink extend upwardly from the angled side portions. A lens is mounted at the bottom of the angled side portions. The cooling fins are not viewable from below the lamp, where the light source is viewable, and accordingly do not obstruct the view of the light source whatsoever.

It is an object of the present invention to provide a lighting fixture.

It is another object of the present invention to provide a lighting fixture that generally blocks the light source from direct viewing by a person.

It is another object of the present invention to provide a lighting fixture that provides for cooling of the light source.

It is a further object of the present invention to provide a lighting fixture that has a combined heatsink and valance.

It is a further object of the present invention to provide a lighting fixture that is aesthetically pleasing.

### SUMMARY OF THE INVENTION

In accordance with one aspect of the present invention there is disclosed a novel lighting fixture comprising a base portion and at least one valance portion oriented so as to project outwardly from the base portion. The at least one valance portion is connected in heat conductive relation to the base portion, to thereby act as a heatsink. There is at least one light source mounted on one of the base portion and the at least one valance portion, such that the at least one valance portion is substantially adjacent the at least one light source, to thereby obstruct the direct viewing of the at least one light source from beyond the at least one valance portion when the lighting fixture is installed on a supporting structure.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described herein below.

### BRIEF DESCRIPTION OF THE DRAWINGS

The novel features which are believed to be characteristic of the lighting fixture according to the present invention, as to its structure, organization, use and method of operation, together with further objectives and advantages thereof, will be better understood from the following drawings in which a presently preferred embodiment of the invention will now be illustrated by way of example. It is expressly understood, however, that the drawings are for the purpose of illustration and description only, and are not intended as a definition of the limits of the invention. In the accompanying drawings:

FIG. 1 is a perspective view from below and to the front left of the first preferred embodiment lighting fixture according to the present invention installed in place under a shelf;

FIG. 2 is a perspective view of the first preferred embodiment lighting fixture of FIG. 1, and is similar to FIG. 1, but removed from the shelf;

FIG. 3 is a perspective view from below and to the front right of the first preferred embodiment lighting fixture of FIG. 2;

FIG. 4 is a perspective view from below and to the back right of the first preferred embodiment lighting fixture of FIG. 2;

FIG. 5 is an enlarged perspective view from below and to the right of the first preferred embodiment lighting fixture of FIG. 2, but with one end cap removed, for the sake of clarity;

FIG. 6 is a front elevational view of the first preferred embodiment lighting fixture of FIG. 2;

FIG. 7 is a rear elevational view of the first preferred embodiment lighting fixture of FIG. 2;

FIG. 8 is a bottom plan view of the first preferred embodiment lighting fixture of FIG. 2;

FIG. 9 is a right end elevational view of the first preferred embodiment lighting fixture of FIG. 2;

FIG. 10 is a left end elevational view of the first preferred embodiment lighting fixture of FIG. 2;

FIG. 11 is a right end elevational view of the first preferred embodiment lighting fixture of FIG. 2, but with the near end cap removed and with the far end cap in place for the sake of clarity;

FIG. 12 is a left end elevational view of the first preferred embodiment lighting fixture of FIG. 2, but with both end caps removed;

FIG. 13 is a perspective view from below of the second preferred embodiment lighting fixture according to the present invention;

FIG. 14 is a bottom plan view of the second preferred embodiment lighting fixture of FIG. 13;

FIG. 15 is a right end elevational view of the second preferred embodiment lighting fixture of FIG. 13;

FIG. 16 is a right end elevational view similar to FIG. 15, but with the near end cap removed and with the far end cap in place for the sake of clarity;

FIG. 17 is a bottom plan view of the third preferred embodiment lighting fixture according to the present invention;

FIG. 18 is a right end elevational view of the third preferred embodiment lighting fixture of FIG. 17;

FIG. 19 is a left end elevational view of the third preferred embodiment lighting fixture of FIG. 17, but with the near end cap removed and with the far end cap in place for the sake of clarity;

FIG. 20 is a right end elevational view of the fourth preferred embodiment lighting fixture according to the present invention;

FIG. 21 is a right end elevational view of the fifth preferred embodiment lighting fixture according to the present invention;

FIG. 22 is a right end elevational view of the sixth preferred embodiment lighting fixture according to the present invention;

FIG. 23 is a right end elevational view of the seventh preferred embodiment lighting fixture according to the present invention;

FIG. 24 is a right end elevational view of the eighth preferred embodiment lighting fixture according to the present invention;

FIG. 25 is a right end elevational view of the ninth preferred embodiment lighting fixture according to the present invention;

FIG. 26 is a right end elevational view of the tenth preferred embodiment lighting fixture according to the present invention;

FIG. 27 is a right end elevational view of the eleventh preferred embodiment lighting fixture according to the present invention;

FIG. 28 is a right end elevational view of the twelfth preferred embodiment lighting fixture according to the present invention;

FIG. 29 is a right end elevational view of the thirteenth preferred embodiment lighting fixture according to the present invention;

FIG. 30 is a right end elevational view of the fourteenth preferred embodiment lighting fixture according to the present invention;

FIG. 31 is a right end elevational view of the fifteenth preferred embodiment lighting fixture according to the present invention; and,

FIG. 32 is a right end elevational view of the sixteenth preferred embodiment lighting fixture according to the present invention.

### DETAILED DESCRIPTION OF THE PREFERRED EMBODIMENTS

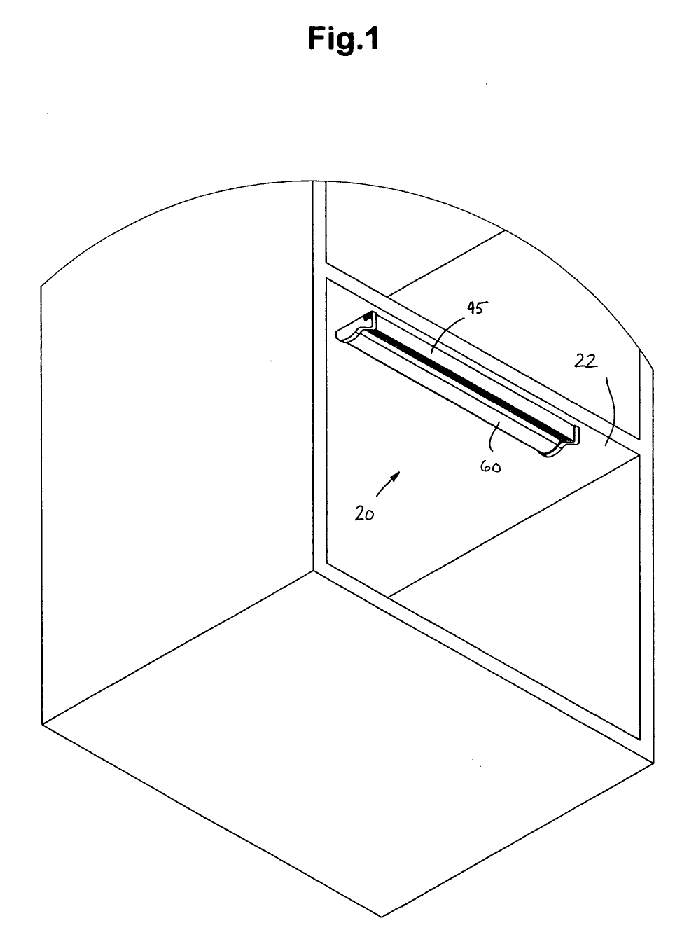

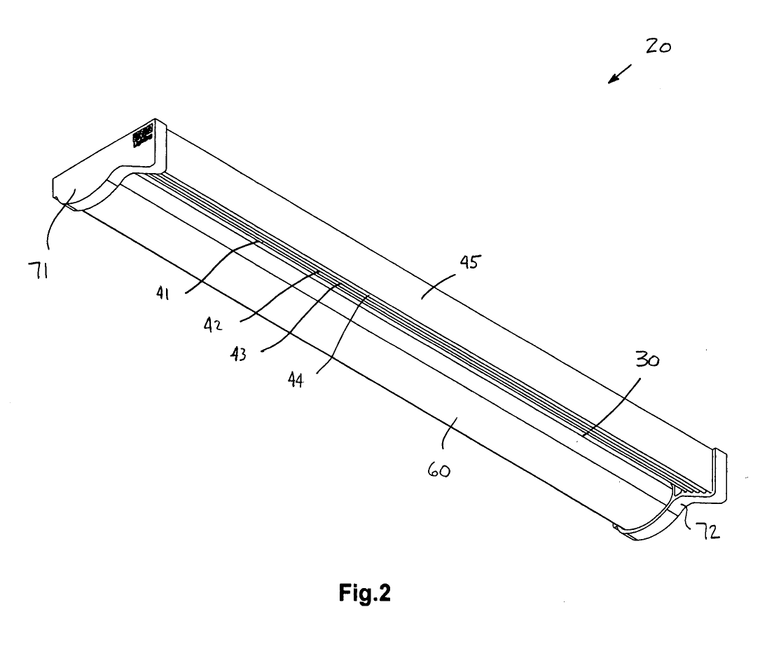

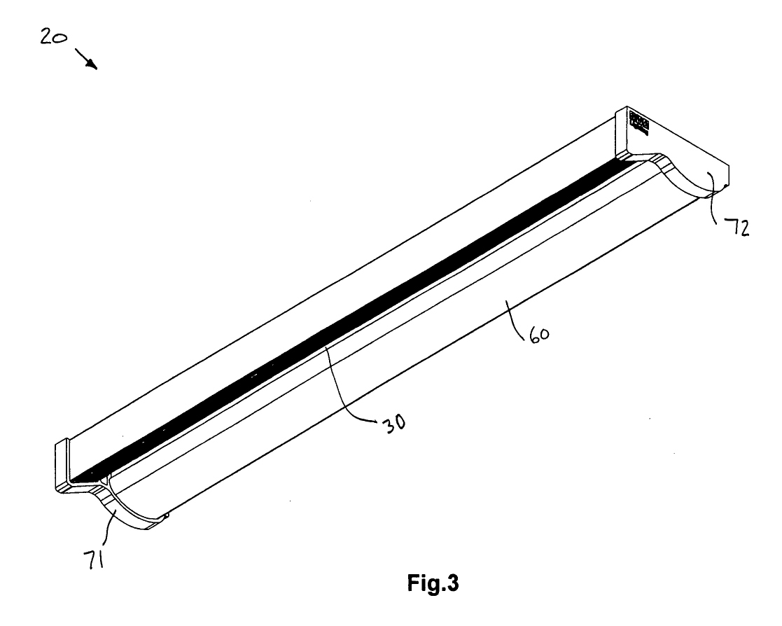

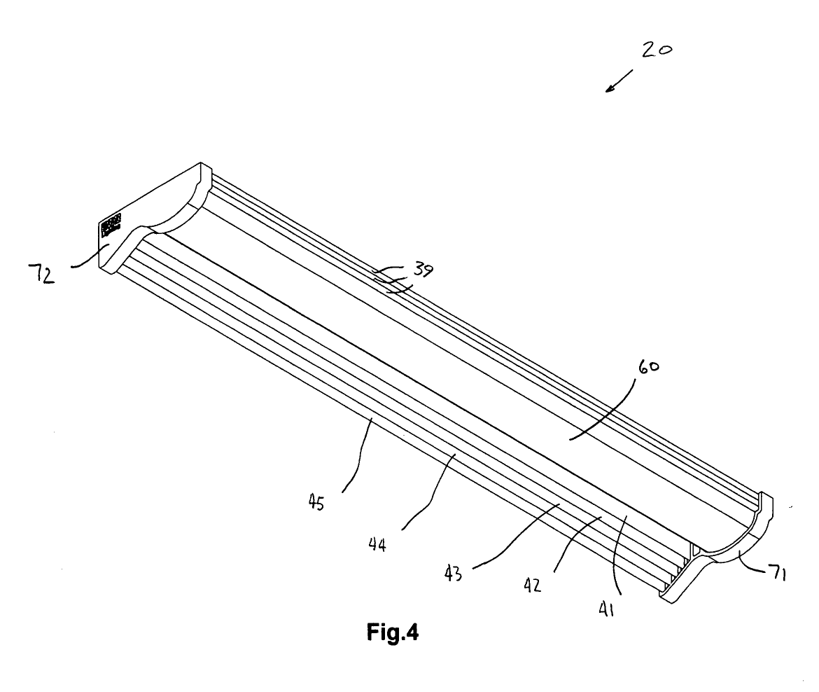

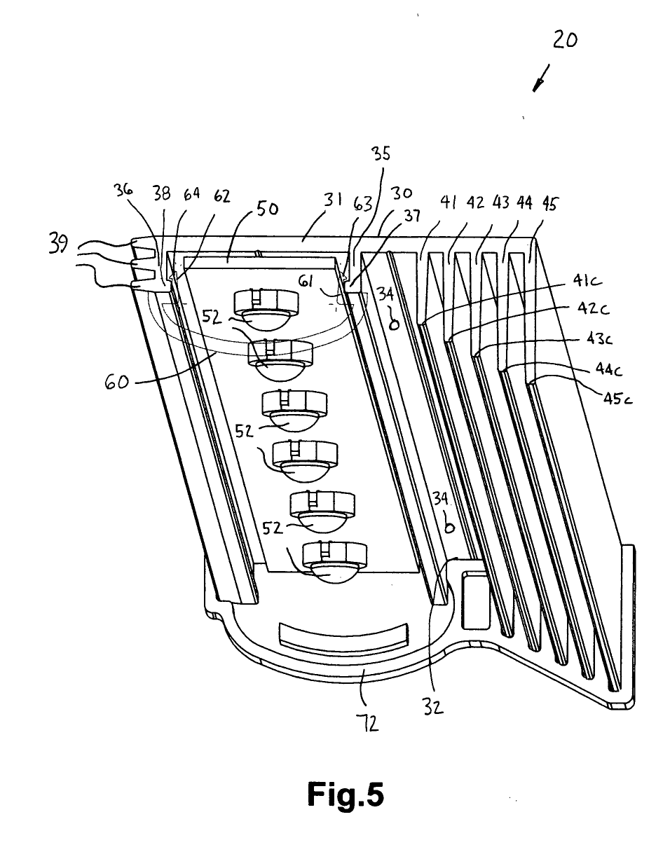

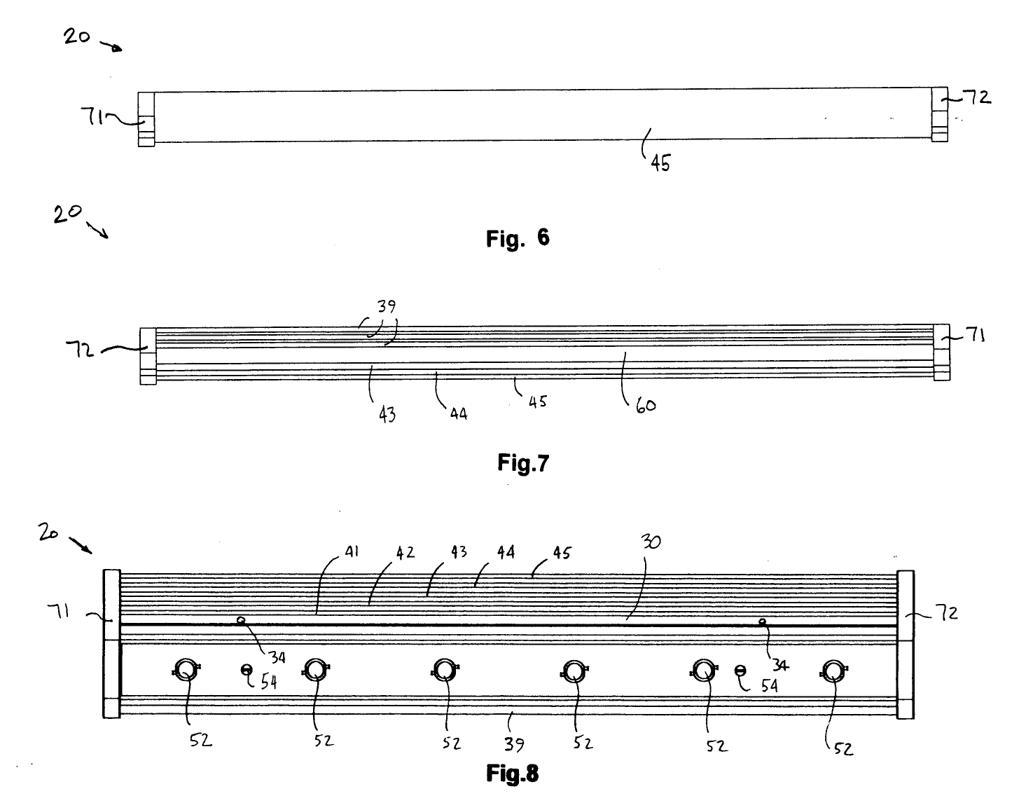

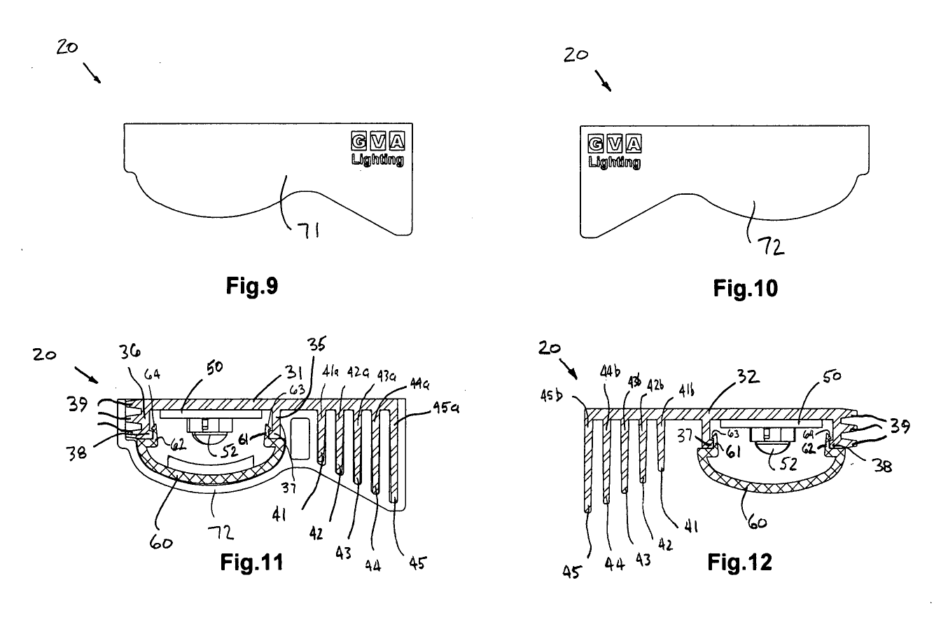

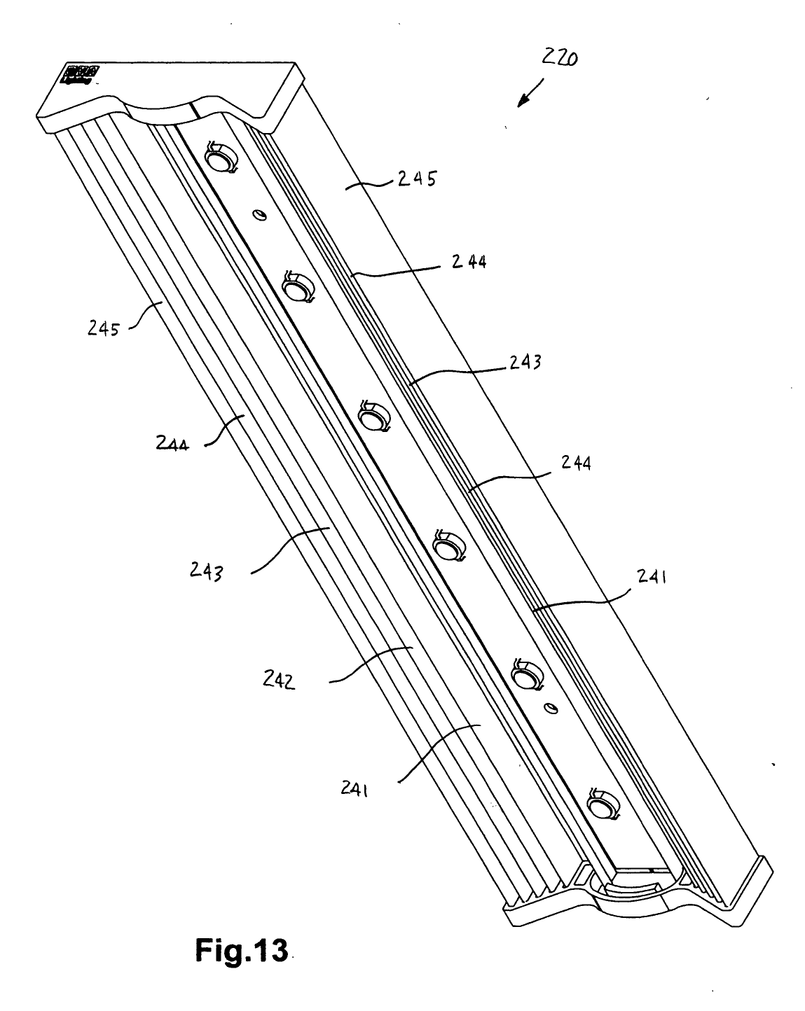

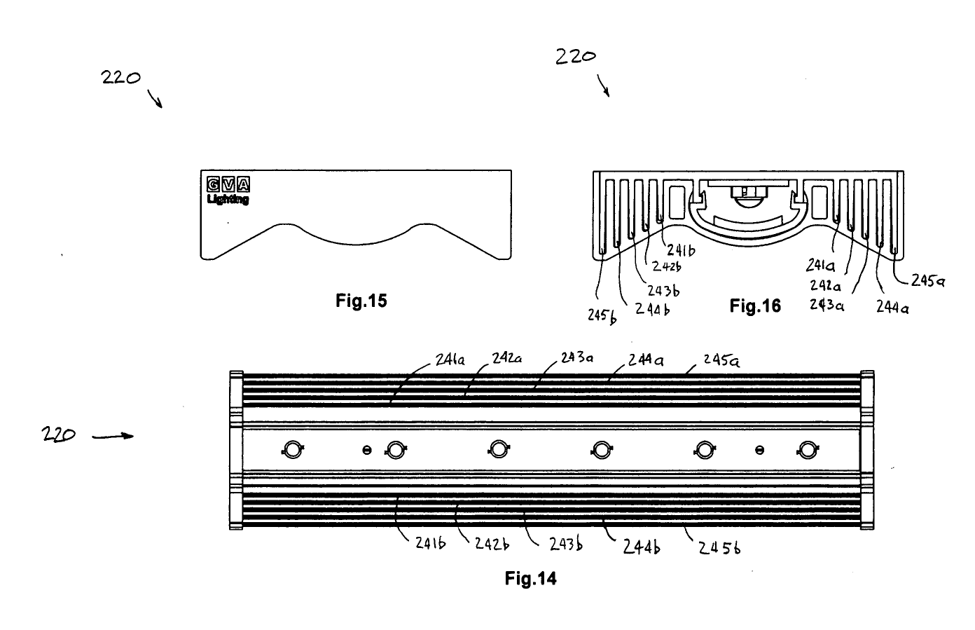

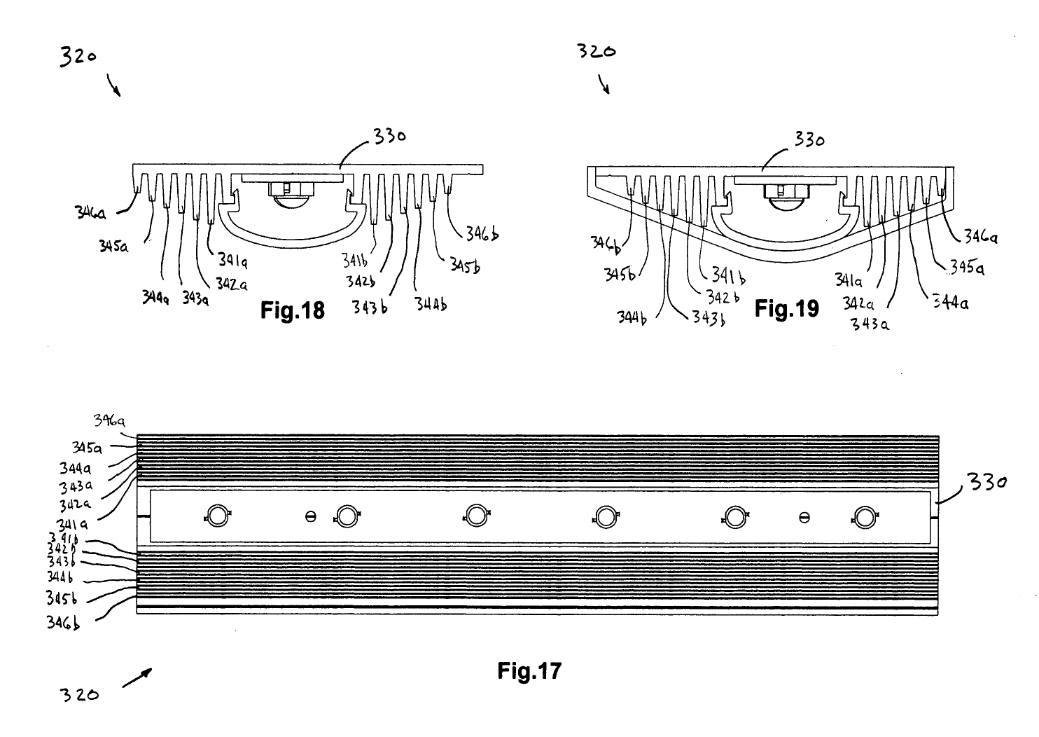

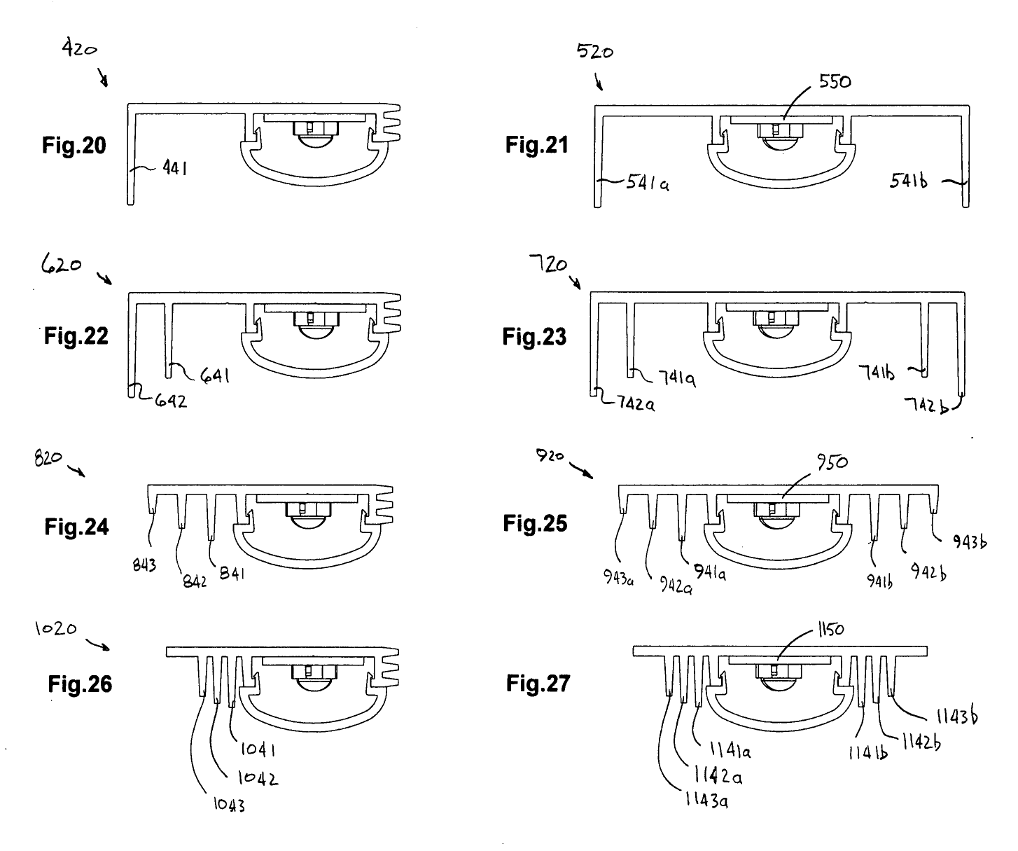

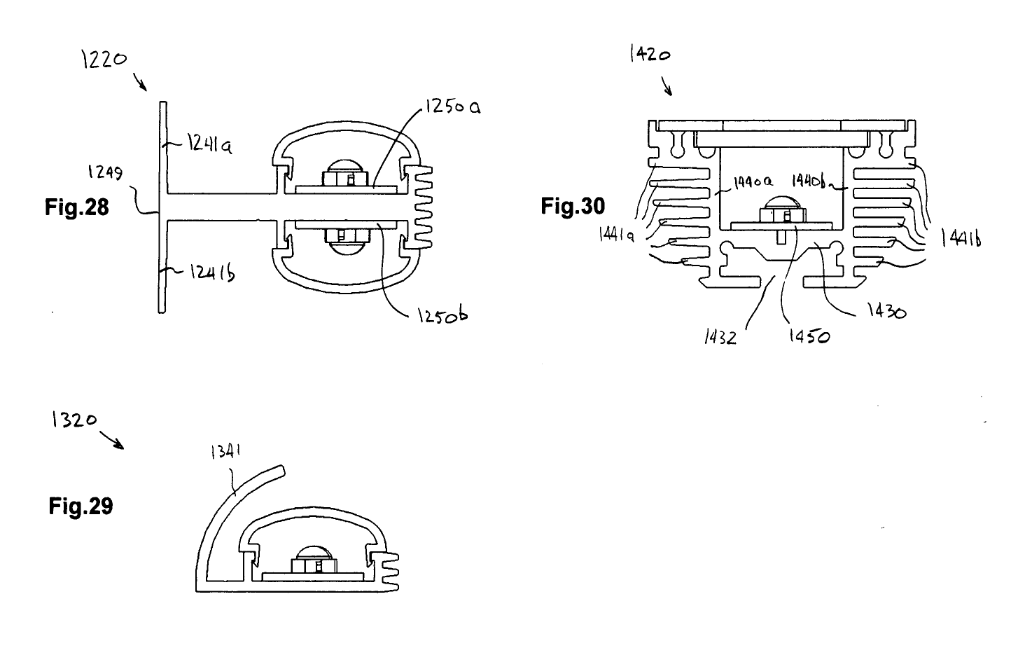

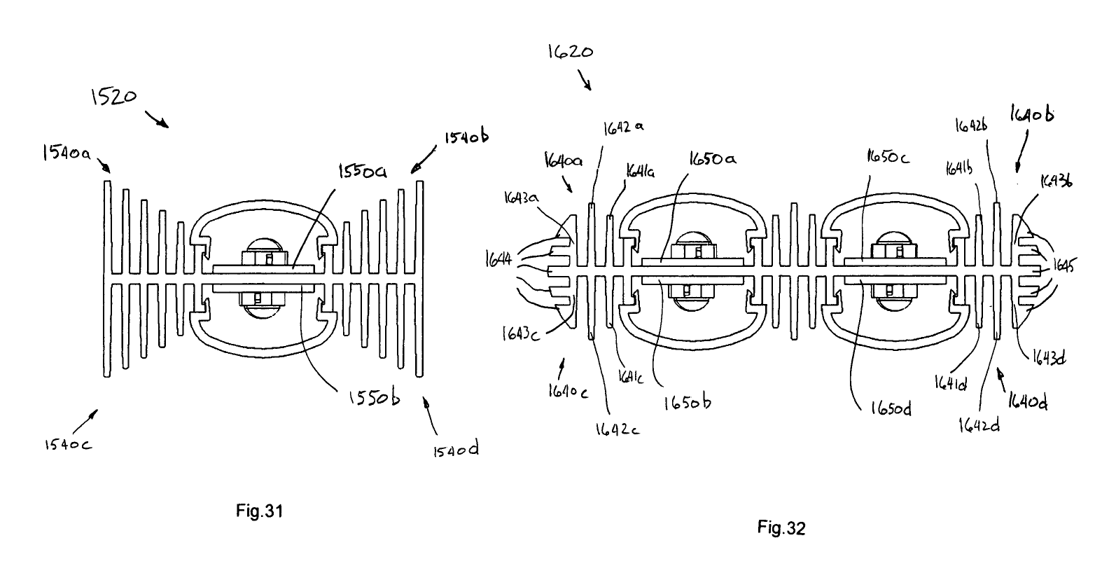

Referring to FIGS. 1 through 32 of the drawings, it will be noted that FIGS. 1 through 12 illustrate a first preferred embodiment of the lighting fixture of the present invention, FIGS. 13 through 16 illustrate a second preferred embodiment of the lighting fixture of the present invention, FIGS. 17 through 19 illustrate a third preferred embodiment of the lighting fixture of the present invention, FIG. 20 illustrates a fourth preferred embodiment of the lighting fixture of the present invention, FIG. 21 illustrates a fifth preferred embodiment of the lighting fixture of the present invention, FIG. 22 illustrates a sixth preferred embodiment of the lighting fixture of the present invention, FIG. 23 illustrates a seventh preferred embodiment of the lighting fixture of the present invention, FIG. 24 illustrates an eighth preferred embodiment of the lighting fixture of the present invention, FIG. 25 illustrates a ninth preferred embodiment of the lighting fixture of the present invention, FIG. 26 illustrates a tenth preferred embodiment of the lighting fixture of the present invention, FIG. 27 illustrates an eleventh preferred embodiment of the lighting fixture of the present invention, FIG. 28 illustrates a twelfth preferred embodiment of the lighting fixture of the present invention, FIG. 29 illustrates a thirteenth preferred embodiment of the lighting fixture of the present invention, FIG. 30 illustrates a fourteenth preferred embodiment of the lighting fixture of the present invention, FIG. 31 illustrates a fifteenth preferred embodiment of the lighting fixture of the present invention, and FIG. 32 illustrates a sixteenth preferred embodiment of the lighting fixture of the present invention.

Reference will now be made to FIGS. 1 through 12, which show a first preferred embodiment of the lighting fixture of the present invention, as indicated by general reference numeral 20. The first preferred embodiment lighting fixture 20 comprises a substantially flat elongate base portion 30 having a first end 31 and a second end 32, and having a pair of mounting apertures 34 therein. A fastening means such as suitable threaded fasteners (not specifically shown) may be used to fasten the lighting fixture to a supporting structure, such as a shelf 22, as is shown in FIG. 1, a ceiling, a display unit, a wall, and so on. The threaded fasteners may also engage cooperating nuts (not specifically shown) that are shaped and dimensioned to be retained within a recess in a track type mounting structure, or similar. Other alternative types of fastening means may also be used, such as clips, rivets, double-sided tape, and so on.

The lighting fixture 20 also comprises at least one valance portion, and in the first preferred embodiment as illustrated, comprises a plurality of valance portions, having at least an inner valance portion 41 and an outer valance portion 45, and at least one intermediate valance portion disposed between the inner valance portion and the outer valance portion. More specifically, there is a first valance portion 41 (the inner valance portion), a second valance portion 42, a third valance portion 43, a fourth valance portion 44, and a fifth valance portion 45 (the outer valance portion). The second, third and fourth valance portions 42, 43, 44 are intermediate valance portions.

The plurality of valance portions, namely the first valance portion 41, the second valance portion 42, the third valance portion 43, the fourth valance portion 44 and the fifth valance portion 45 are each elongate and have first ends 41a, 42a, 43a, 44a and 45a, respectively, and second ends 41b, 42b, 43b, 44b and 45b respectively. Further, the valance portions 41, 42, 43, 44 and 45 are each oriented so as to project outwardly from the base portion 30. In the first preferred embodiment, as illustrated, the five valance portions 41, 42, 43, 44 and 45 each project outwardly in a substantially perpendicular orientation to the base portion 30, and are substantially parallel one to the other. Alternatively, the five valance portions could each project outwardly at an angled orientation to the base portion 30, and can be parallel one to another or can each be oriented at a selected angle. Further, there could be more than five valance portions or fewer than five valance portions.

As can be readily seen in the Figures, the valance portions 41, 42, 43, 44 and 45 are graduated in size such that the fifth (outer) valance portion 45 projects perpendicularly outwardly from the base portion 30 farther than the first (inner) valance portion 41 projects perpendicularly outwardly from the base portion 30. More specifically, the fifth valance portion 45 projects perpendicularly outwardly from the base portion 30 farther than the fourth valance portion 44, the fourth valance portion 44 projects perpendicularly outwardly from the base portion 30 farther than the third valance portion 43, the third valance portion 43 projects perpendicularly outwardly from the base portion 30 farther than the second valance portion 42, and the second valance portion 42 projects perpendicularly outwardly from the base portion 30 farther than the first valance portion 41. Accordingly, the bottom edges 41c, 42c, 43c, 44c and 45c of the of five valance portions 41,42,43,44 and 45 appear to form a slope, which is aesthetically pleasing, and also determines the cut-off angle.

In first preferred embodiment of the lighting fixture 20 of the present invention, the first valance portion 41, the second valance portion 42, the third valance portion 43, the fourth valance portion 44 and the fifth valance portion 45 are each connected in heat conductive relation to the base portion 30, to thereby each act as a heatsink. As can be readily seen in the figures, the five valance portions 41, 42, 43, 44 and 45 are each equidistant one from the other, for the purpose of maximizing heat dissipation.

There is also at least one light source mounted on either the base portion 30 or on one of the valance portions. In the preferred embodiment, as illustrated, the at least one light source comprises a light emitting diode light strip 50, also known as a linear LED light engine. The light emitting diode light strip has a plurality of light emitting diodes 52 and is mounted on the base portion 30 by means of suitable threaded fasteners 54.

The inner valance portion 41 is substantially adjacent the light emitting diode light strip 50. The first valance portion 41 (the inner valance portion), a second valance portion 42, a third valance portion 43, a fourth valance portion 44, and a fifth valance portion 45 (the outer valance portion) thereby obstruct the direct viewing of the light emitting diode light strip 50 from beyond the outer valance portion 45 when the lighting fixture is installed on a supporting surface such as the shelf 22.

In the preferred embodiment, as illustrated, the base portion 30 and the five valance portions are integrally formed one with the others, and are preferably extruded from a suitable metal, such as aluminum. Other suitable forms of design and manufacture of the base portion 30 and the valance portions may also be used.

The base portion 30 further comprises three small heat sink fins 39 extending outwardly from the edge of the base portion 30 opposite the five valance portions 41, 42, 43, 44 and 45.

The lighting fixture 20 further comprises a lens cover 60 that is removably mounted on the base portion 30 so as to be disposed over the at least one light source, namely the light emitting diode light strip 50. The base portion 30 further comprises first mounting flange 35 and a second mounting flange 36 for receiving the lens cover 60. The first mounting flange 35 terminates in the first lip portion 37 and second mounting flange 36 terminates in a second lip portion 38. The lens cover 60 has a first flange portion 61 with a first protruding edge portion 63 that engages the first lip portion 37 of the first mounting flange 35 and a second flange portion 62 with a second protruding edge portion 64 that engages the second lip portion 38 of the second mounting flange 36, to thereby retain the lens cover 60 in place on the base portion 30.

The lighting fixture 20 further comprises a first end cap 71 and a second end cap 72, which are preferably made from a pliable material. The first end cap 71 securely engages the lighting fixture 20 at the first end 31 of the base member 30 and the first ends 41a, 42a, 43a, 44a and 45a of the plurality of valance portions 41, 42, 43, 44 and 45, and the second end cap 72 securely engages the lighting fixture 50 at the second end 32 of the base member 30 and the second end 41b, 42b, 43b, 44b and 45b of the plurality of valance portions 41, 42, 43, 44 and 45.

Reference will now be made to FIGS. 13 through 16, which show a second preferred embodiment of the lighting fixture of the present invention, as indicated by the general reference 220. The second preferred embodiment of the lighting fixture 220 is similar to the first preferred embodiment lighting fixture 20 except that in addition to the first plurality of five valance portions 241a, 242a, 243, 244a and 245a disposed adjacent the front of the base portion 230 of the lighting fixture, there is also a second plurality of five of valance portions 241b, 242b, 243b,244b and 245b disposed adjacent the rear of the base portion 230 of the lighting fixture 220. Accordingly, direct viewing of the light source 222 is obstructed from both in front and behind the lighting fixture 220. The second preferred embodiment lighting fixture 220 is mounted to a supporting structure in the same manner as is the first preferred embodiment lighting fixture 20.

Reference will now be made to FIGS. 17 through 19 which illustrate a third preferred embodiment of the lighting fixture of the present invention, as indicated by the general reference 320. The third preferred embodiment of the lighting fixture 320 is similar to the second preferred embodiment lighting fixture 220 except that the inner valance portions 341a and 341b project perpendicularly outwardly from the base portion farther than the outer valance portions 346a and 346b and project perpendicularly outwardly from the base portion 330. Further, the intermediate valance portions 342a, 343a, 344, 345a and 342b, 343b, 344b and 345b are also staggered in size. As can readily be seen in the figures, the first (inner) valance portions 341a and 341b project perpendicularly outwardly from the base portion 330 farther than the second valance portions 342a and 342b, the second valance portions 342a and 342b project perpendicularly outwardly from the base portion farther than the third valance portions 343a and 343b, the third valance portions 343a and 343b project perpendicularly outwardly from the base portion 330 farther than the fourth valance portions 344a and 344b, the fourth valance portions 344a and 344b project perpendicularly outwardly from the base portion 330 farther than the fifth valance portions 345a and 345b, and the fifth valance portions project outwardly from the base portion 330 farther than the sixth (outer) valance portions 346a and 346b.

Reference will now be made to FIG. 20 illustrates a fourth preferred embodiment of the lighting fixture of the present invention, as indicated by the general reference 420. The fourth preferred embodiment of the lighting fixture 420 is similar to the first preferred embodiment lighting fixture 20 except that there is only one valance portion 441.

FIG. 21 illustrates a fifth preferred embodiment of the lighting fixture of the present invention, as indicated by the general reference 520. The fifth preferred embodiment of the lighting fixture 520 is similar to the fourth preferred embodiment lighting fixture 420 except that there is one valance portion 541a and 541b on each side of the light source 550.

FIG. 22 illustrates a sixth preferred embodiment of the lighting fixture of the present invention, as indicated by the general reference 620. The sixth preferred embodiment of the lighting fixture 620 is similar to the first preferred embodiment lighting fixture 20 except that there are only two valance portions 641 and 642.

FIG. 23 illustrates a seventh preferred embodiment of the lighting fixture of the present invention, as indicated by the general reference 720. The seventh preferred embodiment of the lighting fixture 720 is similar to the sixth preferred embodiment lighting fixture 620 except that there are two valance portions 741a, 742a, 741b and 742b on each side of the light source 750.

FIG. 24 illustrates an eighth preferred embodiment of the lighting fixture of the present invention, as indicated by the general reference 820. The eighth preferred embodiment of the lighting fixture 820 is similar to the third preferred embodiment lighting fixture 320 except that there are only three valance portions 841, 842 and 843.

FIG. 25 illustrates a ninth preferred embodiment of the lighting fixture of the present invention, as indicated by the general reference 920. The ninth preferred embodiment of the lighting fixture 920 is similar to the eighth preferred embodiment lighting fixture 820 except that there are three valance portions 941a, 942a, 943a, 941b, 942b and 943b on each side of the light source 950.

FIG. 26 illustrates a tenth preferred embodiment of the lighting fixture of the present invention, as indicated by the general reference 1020. The tenth preferred embodiment of the lighting fixture 1020 is similar to the eighth preferred embodiment lighting fixture 820 except that the three valance portions 1041, 1042 and 1043 are spaced much closer together one to another.

FIG. 27 illustrates an eleventh preferred embodiment of the lighting fixture of the present invention, as indicated by the general reference 1120. The eleventh preferred embodiment of the lighting fixture 1120 is similar to the first preferred embodiment lighting fixture 20 except that there are three closely spaced valance portions 1141a, 1142a, 1143a, 1141b, 1142b and 1143b on each side of the light source 1150.

FIG. 28 illustrates a twelfth preferred embodiment of the lighting fixture of the present invention, as indicated by the general reference 1220. The twelfth preferred embodiment of the lighting fixture 1220 is similar to the fourth preferred embodiment lighting fixture 420 except that there are two light sources 1250a and 1250b, one above the other, and two substantially coplanar valance portions 1241a and 1241b, one valance portion blocking each of the too light sources 1250a and 1250b. The twelfth preferred embodiment lighting fixture 1220 would typically be mounted by means other than threaded fasteners, and would probably be suspended, supporting structure, as there is no flat surface to readily engage a support structure, other than the outer surface 1249 of the valance portions 1241a, 1241b.

FIG. 29 illustrates a thirteenth preferred embodiment of the lighting fixture of the present invention, as indicated by the general reference 1320. The thirteenth preferred embodiment of the lighting fixture 1320 is similar to the fourth preferred embodiment lighting fixture 420 except that the valance portion 1341 is curved. The thirteenth preferred embodiment lighting fixture 1320 would typically be mounted by means other than threaded fasteners, as the curved valance portion 1341 would block ready access to the location of the mounting apertures that would receive threaded fasteners.

FIG. 30 illustrates a fourteenth preferred embodiment of the lighting fixture of the present invention, as indicated by the general reference 1420. The fourteenth preferred embodiment of the lighting fixture 1420 is similar to the first preferred embodiment lighting fixture 20 except that each of the valance portion has a main valance portion 1440a, 1440b on each side of the light source 1450 and a plurality of secondary valance portions 1441a, 1441b extending perpendicularly outwardly from the main valance portions 1440a, 1440b. Further, the fourteenth preferred embodiment lighting fixture 1420 is mounted by means threaded fasteners that engage cooperating nuts (not specifically shown) that are shaped and dimensioned to be retained within the elongate recess 1432 in the base portion 1430.

FIG. 31 illustrates a fifteenth preferred embodiment of the lighting fixture of the present invention, as indicated by the general reference 1520. The preferred embodiment of the lighting fixture 1520 is similar to the second preferred embodiment lighting fixture 220 except that there are two light sources 1550a and 1550b, one above the other, and two pairs of valance portions 1540a, 1540b, 1540c and 1540d, one pair of valance portions 1540a, 1540b, 1540c and 1540d blocking each of the too light sources 1550a and 1550b.

FIG. 32 illustrates a sixteenth preferred embodiment of the lighting fixture of the present invention, as indicated by the general reference 1620. The sixteenth preferred embodiment of the lighting fixture 1620 is similar to the fifteenth preferred embodiment lighting fixture 1520 except that there is a first pair of light sources 1650a and 1650b, one above the other, and a second pair of light sources 1650c and 1650d, one above the other. The valance portions 1640a, 1640b, 1640c and 1640d are also shaped differently. Each set of valance portions has a first valance portion 1641a, 1641b, 1641c and 1641d, a second valance portion 1642a, 1642b, 1642c and 1642d and a third valance portion 1643a, 1643b, 1643c and 1643d. The first valance portions 1641a, 1641b, 1641c and 1641d and the second valance portion 1642a, 1642b, 1642c and 1642d are each thin and flat, and substantially perpendicular to the base portion 1630, while the third valance portions 1643a, 1643c have a plurality of secondary valance portions 1644 extending outwardly therefrom, and the third valance portions 1643b, 1643d have a plurality of secondary valance portions 1645 extending outwardly therefrom.

As can be understood from the above description and from the accompanying drawings, the present invention provides a lighting fixture that generally blocks the light source from direct viewing by a person, that provides for cooling of the light source, that has a combined heatsink and valance, and that is aesthetically pleasing, which features together are unknown in the prior art.

Other variations of the above principles will be apparent to those who are knowledgeable in the field of the invention, and such variations are considered to be within the scope of the present invention. Further, other modifications and alterations may be used in the design and manufacture of the lighting fixture of the present invention without departing from the spirit and scope of the accompanying claims.

1. A lighting fixture comprising;
a base portion;
at least one valance portion oriented so as to project outwardly from said base portion, and connected in heat conductive relation to said base portion, to thereby act as a heatsink; and,
at least one light source mounted on one of said base portion and said at least one valance portion, such that said at least one valance portion is substantially adjacent said at least one light source, to thereby obstruct the direct viewing of said at least one light source from beyond said at least one valance portion when said lighting fixture is installed on a supporting structure and,
wherein said at least one valance portion comprises a plurality of valance portions, having at least an inner valance portion and an outer valance portion wherein said plurality of valance portions are each oriented so as to project outwardly from said base portion, and are each connected in heat conductive relation to said base portion, to thereby each act as a heatsink.

2. (canceled)

3. The lighting fixture of claim 1, wherein each said valance portion projects outwardly in a substantially perpendicular orientation to said base portion.

4. The lighting fixture of claim 1, wherein said base portion is elongate.

5. The lighting fixture of claim 1, wherein said plurality of valance portions are each elongate.

6. The lighting fixture of claim 1, wherein said base portion is substantially flat.

7. The lighting fixture of claim 1, wherein said base portion and said at least one valance portion is made from metal.

8. The lighting fixture of claim 7, wherein said base portion and said at least one valance portion are extruded.

9. The lighting fixture of claim 1, wherein said base portion and said at least one valance portion are integrally formed one with the others.

10. The lighting fixture of claim 1, wherein said valance portions are substantially parallel one to the other.

11. The lighting fixture of claim 1, wherein said outer valance portion projects outwardly from said base portion farther than said inner valance portion projects outwardly from said base portion.

12. The lighting fixture of claim 1, further comprising at least one intermediate valance portion disposed between said inner valance portion and said outer valance portion.

13. The lighting fixture of claim 12, wherein said outer valance portion projects outwardly from said base portion farther than said at least one intermediate valance portion project outwardly from said base portion, and said at least one intermediate valance portion projects outwardly from said base portion farther than said inner valance portion projects outwardly from said base portion.

14. The lighting fixture of claim 13, wherein said outer valance portion, each of said at least one intermediate valance portion, and said inner valance portion are equidistant one from the other.

15. The lighting fixture of claim 1, further comprising a lens cover mounted on said base portion so as to be disposed over said at least one light source.

16. The lighting fixture of claim 1, wherein said base portion further comprises first mounting flange and a second mounting flange for receiving said lens cover.

17. The lighting fixture of claim 16, wherein said first mounting flange terminates in a first lip portion and second mounting flange terminates in a second lip portion, and said lens cover has a first protruding edge portion that engages said first lip portion of said first mounting flange and a second protruding edge portion that engages said second of the portion of said second mounting flange, to thereby retain said lens cover in place on said base portion.

18. The lighting fixture of claim 17, wherein said lens cover is removably mountable on said base portion.

19. The lighting fixture of claim 1, wherein said base member has a first end and a second end and said plurality of valance portions each have a first end and a second end.

20. The lighting fixture of claim 19, further comprising a first end cap and a second end cap, wherein said first end cap securely engages said lighting fixture at said first end of said base member and said first end of said plurality of valance portions, and said second end cap securely engages said lighting fixture at said second end of said base member and said second end of said plurality of valance portions.
